(19) United States
(12) Patent Application Publication
(10) Pub. No.: US 2011/0127778 A1
(43) Pub. Date: Jun. 2, 2011

(54) METHOD AND APPARATUS FOR EXTRACTING ENERGY FROM BIOMASS

(76) Inventor: John Kinney, Bangor (GB)

(21) Appl. No.: 13/003,390

(22) PCT Filed: Jul. 8, 2009
(86) PCT No.: PCT/EP09/04939

§ 371 Date: Jan. 10, 2011

(30) Foreign Application Priority Data
Jul. 11, 2008 (GB) 0812669.0

(51) Int. Cl. G21D 5/00; F02C 1/04; C10L 3/00; C10L 1/14; H02K 7/18

(52) U.S. Cl. 290/1 R; 60/644.1; 60/682; 48/204; 44/307; 44/311

(57) ABSTRACT

A method and apparatus for extracting useful energy from biomass fuels as part of a hybrid electricity generating thermal power plant, utilising both a primary heat source, such as coal, gas, oil or nuclear power, and a secondary heat source in the form of biomass, whereby the biomass is oxidised in aqueous solution in a supercritical water oxidation (SCWO) process utilising energy from the primary heat source to heat and compress a feed stream of water to a temperature and pressure at or beyond its critical point.

This invention relates to a method and apparatus for extracting useful energy from biomass, and in particular to a method and apparatus for extracting energy from biomass in a power generation plant.

The term biomass is used to describe a wide variety of different organic materials derived from natural sources, including wood waste, agricultural crops, such as grass, silage, and grain and animal waste, such as animal litter which is a mixture of cellulosic bedding material and animal manure. The present invention is particularly concerned with extracting useful energy from biomass material with a high water content that renders it energetically unsuitable for generation by conventional combustion, such as :—
sewage sludge,
soft agricultural crops such as grasses,
other agricultural products such as fruit and vegetable.
animal manure
food waste
materials originating from animal rendering processes
algae
Garden waste
municipal green waste such as grass cuttings

It has long been recognised that raw biomass can be burnt and the heat produced during combustion used directly, e.g. for heating water or the interior of a building, or for generating steam for driving a steam turbine connected to an electricity generator. However, the high water content of biomass, typically 80% or more, leads to poor efficiency as a lot of energy is required to dry the material, converting the water from liquid to vapour, before combustion can take place and useful energy can be extracted. Therefore biomass typically has a relatively low calorific value compared to conventional fossil fuels.

Raw biomass can first be converted into a gaseous fuel or fermented to produce ethanol to improve its calorific value. However, such known methods for improving the calorific value of biomass require considerable amounts of energy. Therefore the use of biomass as an energy source remains uneconomical in terms of energy balance using existing combustion processes, despite the fact that it is highly desirable as a fuel due to its carbon neutral nature.

Supercritical Water Oxidisation (SCWO), sometimes referred to as Hydrothermal Oxidation, is a high-efficiency, thermal oxidation process that takes place in water at elevated pressures and temperatures above the thermodynamic critical point of water (220 bar/22.1 MPa and 374° C.). Above its critical point, water exists only as a fluid and the distinction between vapour and liquid vanishes. Under supercritical conditions, the density of the water is around one tenth of that of normal liquid water and solubility behaviour is closer to that of high pressure steam than to liquid water. Under such conditions, chemical reactions proceed as gas-phase free radical reactions involving the formation of a variety of intermediary species and related sub-reactions as the reaction proceeds to completion. The molecular dispersion of organic and oxidant reactants with a single phase under supercritical conditions, in conjunction with the high temperature, provides rapid reaction rates. The process is fully enclosed and does not produce hazardous air pollutants typically produced during the combustion of waste. For this reason alone, SCWO is typically proposed for the treatment of waste streams containing high concentrations of water.

In a typical SCWO waste treatment system, organic waste is combined with an oxidiser (such as liquid oxygen, hydrogen peroxide or air) in aqueous solution with water at elevated temperature and pressure above the critical point of water (typically at a pressure of great than 221 bar and a temperature of above 550° C.) in a reactor for residence times in the order to 10 to 30 seconds. Once the reaction has completed, the reactor effluent is cooled, depressurised and separated into gaseous and liquid streams. The process is completely enclosed up to the point of final discharge to the environment, facilitating post processing and monitoring prior to release.

Because of SCWO's ability to oxidise high-moisture content organic materials without any phase change and resultant loss of latent heat, there is potential for developing SCWO as an alternative to combustion for extracting energy from biomass. However, the large amount of energy required to create the high temperature and pressure required for supercritical reaction conditions has caused little consideration to be given to the application of SCWO for power generation.

According to a first aspect of the present invention there is provided a method of extracting energy from biomass, comprising the steps of raising the temperature and pressure of a feed stream of water to supercritical levels by means of a primary source of energy, and utilising said feed stream of water to oxidise biomass in a supercritical water oxidation (SCWO) process in a reactor to further increase the temperature and/or pressure of said feed stream of water.

Said biomass may be added to the feed stream of water upstream of the reactor. Alternatively said feed stream may comprise an aqueous slurry of biomass and water.

Preferably the method comprises the further step of generating electricity from said feed stream downstream of the reactor, preferably either directly by passing the feed stream into one or more turbines, such as one or more of a steam turbine and/or a gas turbine and/or a hydro turbine, coupled to one or more electricity generators, or indirectly by transferring heat energy from said feed stream to a working fluid of one or more turbines coupled to one or more electricity generators.

At least part of said feed stream downstream of the reactor may be utilised as a source of energy, in particular as a source of heat and/or potential energy (pressure), either directly or indirectly, for example for community heating.

It is envisaged that numerous methods of extracting energy from the feed stream downstream of the reactor, in the form of heat and/or kinetic energy, may be utilised.

In one embodiment said step of raising the temperature and pressure of said feed stream of water to supercritical levels may comprise heating a first flow of water to a first temperature at a first pressure by means of said primary heat source and compressing said first flow of water to a second pressure, such that the temperature and pressure of the first flow of water are above those of the critical point of water whereby said first flow of water comprises said feed stream. Said biomass may be added to the feed stream downstream of the compression stage.

In an alternative embodiment said step of raising the temperature of said feed stream of water to supercritical levels may comprise heating a first flow of water by means of said primary heat source and heating a second flow of water by indirect heat exchange with said first flow of water whereby said second flow of water comprises said feed stream. By using heat exchangers, the feed stream of the SCWO process can be kept separate from the working medium of the primary power generator, enabling the biomass oxidation process to be integrated into an existing power station without requiring substantial modification to the existing systems.

The second flow of water downstream of the SCWO process may be used to improve the energy efficiency of the power station, by extracting energy from the feed stream downstream of the SCWO process at any point in the power station. For example, energy may be extracted by one or more heat exchange processes with the first flow of water at any stage and/or by passing the second flow of water through one or more turbines.

Preferably said primary heat source comprises at least one of coal, oil, gas or a nuclear reactor.

In one embodiment the method may further comprises the steps of transferring heat from said feed stream of water downstream of said reactor to a further flow of water in one or more heat exchangers and passing said further flow of water into one or more turbines coupled to one or more electricity generators to generate electricity.

Preferably an oxidising agent is fed into said reactor along with said biomass slurry. The oxidising agent may comprises one or more of oxygen, hydrogen peroxide, or air, preferably in liquefied form. The oxidising agent may be generated from water, preferably from the feed stream of water, by UV radiation, electrolysis, other electrochemical processes or any other oxygen generating method. Oxygen consumption is typically the largest overhead associated with SCWO processes. By generating oxygen in situ, for example by electrolysis using readily available electricity from the power plant, this overhead is removed and replaced by a relatively small consumption of electrical power.

The integration of the SCWO process into a conventional solid fuel power station enables the high temperature and high pressure water generated within the boiler of the power station to be utilised, either directly or indirectly, as a feed stream for supercritical water oxidation of biomass, enabling the efficient recovery of useful energy from the high water content biomass.

According to a further aspect of the present invention there is provided a hybrid thermal power station for extracting useful energy from biomass fuels comprising means for heating a feed stream of water, by means of direct heating by a primary heat source, such as coal, gas, oil or nuclear power, or by heat exchange with a heat exchange medium heated by said primary heat source, a compressor for compressing said feed stream, whereby the temperature and pressure of said feed stream are increased to a temperature and pressure beyond its critical point, a reactor for receiving said supercritical feed stream for oxidising biomass in aqueous solution in a SCWO process to further heat the feed stream before utilising said feed stream to drive one or more turbines.

The biomass may be added to the feed stream upstream of the reactor and may be added upstream or downstream of the compressor. Said feed stream may comprise an aqueous solution of biomass and water.

According to a further aspect of the present invention, there is provided a method for extracting useful energy from biomass fuels as part of a hybrid electricity generating thermal power plant, utilising both a primary heat source, such as coal, gas, oil or nuclear power, and a secondary heat source in the form of biomass, whereby the biomass is oxidised in aqueous solution in a supercritical water oxidation (SCWO) process utilising energy from the primary heat source to heat and compress a feed stream of water to a temperature and pressure at or beyond its critical point.

Embodiments of the present invention will now be described by way of example only, with reference to the accompanying drawings, in which:—

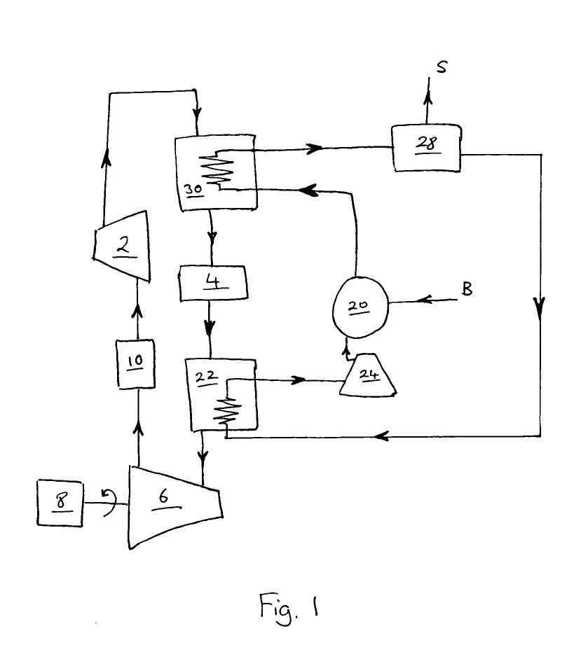

FIG. 1 is a schematic diagram of a hybrid power station according to a first embodiment of the present invention;

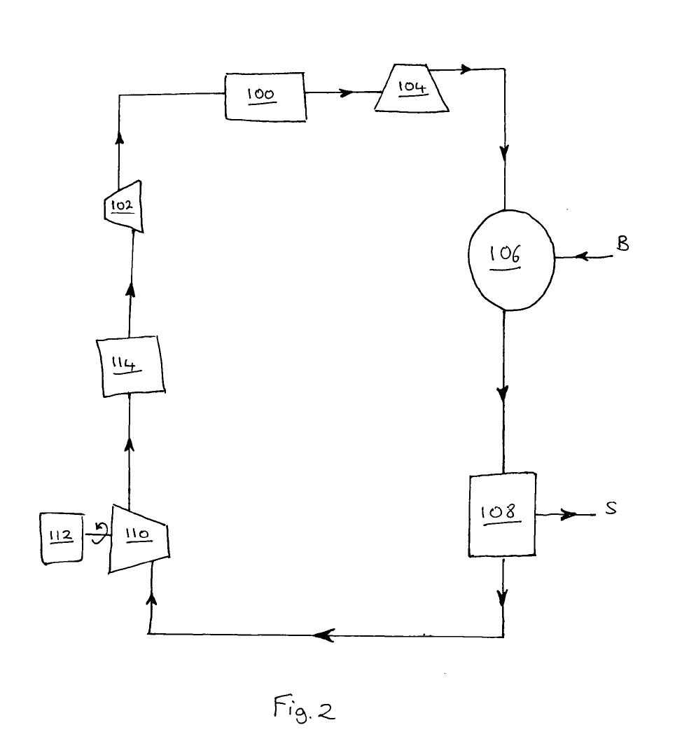

FIG. 2 is a schematic diagram of a hybrid power station according to a second embodiment of the present invention.

A hybrid thermal power station according to a first embodiment of the present invention is illustrated in FIG. 1.

The hybrid system according to the first embodiment is based upon a traditional fossil (e.g. coal, oil or gas) or nuclear fuelled thermal power station, such fuel hereinafter referred to as the primary heat source, having a primary water stream pumped by a water feed pump 2 into a boiler 2 wherein the primary water stream is heated to a temperature of at least 400° C. at a pressure of at least 130 bar by said primary heat source (i.e. to a supercritical temperature and subcritical pressure). The high temperature and high pressure primary water stream is then fed into a steam turbine 6 drivingly connected to a generator 8 for generating electricity before passing through a condenser 10, typically comprising one or more cooling towers, wherein the primary water stream is cooled and condensed before being returned to the boiler 4 by the feed pump 2. This part of the power station is conventional and will not be described in more detail. However, the cycle may include a number of additional reheating stages and/or regeneration stages to improve efficiency, as is known in the art. The temperature of the working medium of the traditional power station is already above the critical point of water. However, the pressure of the working medium is typically below the pressure at the critical point of water. Therefore the working medium can be rendered suitable for use in a SCWO oxidation process by compression to increase the pressure of the working medium without requiring any further heating.

In the first embodiment of the invention, in order to enable biomass fuel sources to contribute to the power generated by the primary heat source, a SCWO biomass oxidising process is provided alongside the primary heat source powered thermal power station, indirectly taking heat from and returning heat to the primary water stream. The SCWO process comprises a reactor 20 supplied with an aqueous biomass slurry B injected into the reactor at high pressure along with a supercritical secondary water stream, said secondary water stream being heated to a temperature of around 540° by heat exchange in a first heat exchanger 22 with said primary water stream downstream of the boiler 4. Alternatively the biomass slurry may be mixed with the secondary water stream upstream of the reactor. The high temperature secondary water stream is then compressed to a pressure of 220 bar in a compressor 24 before entering the reactor 20 at supercritical temperature and pressure. The compressor 24 can be driven directly or indirectly from the steam turbine 6, thus utilising energy from the power station itself. The compression stage may take place before the heat exchange stage.

The biomass feed is diluted as necessary with water to create said aqueous biomass slurry B. The slurry is pressurised to in excess of 150 bar and pre-heated to in excess of 300° C. prior to being fed into the reactor 20. The biomass slurry may be pre-heated by heat exchange with the secondary water stream downstream of the reactor 20, or may be mixed with the secondary water stream downstream of the reactor 20 such that the biomass slurry defines the secondary water stream upstream of the reactor.

An oxidising agent, such as liquid oxygen, hydrogen peroxide or air is added to the reactor. The oxidising agent is supplied in sufficient quantity to effect oxidation of all of the biomass feed. In one embodiment, the oxidising agent may comprise oxygen produced from water by electrolysis, either intrinsically at high pressure, or extrinsically, by electrolysis, swing absorption or cryogenic separation, followed by compression of the oxygen produced to a pressure of 220 bar (or at least 150 bar). Hydrogen produced as a by-product may be either blended with natural gas for combustion in a boiler of the power station or in a gas turbine or may be stored under pressure for subsequent use or as a fuel source, for example for automotive transport. The heat produced by such boiler or gas turbine may be used to heat water to be supplied to one or more steam turbines.

In the reactor an exothermic biomass oxidation process takes place. As the biomass is oxidised, energy is released in the form of heat, increasing the temperature of the secondary water stream to over 600° C. The pressure of the secondary water stream may also increase in the reactor during oxidation of the biomass. Thus the energy released through the exothermic biomass oxidation process is stored as heat energy and potential energy (by increased pressure).

The residence time for the reaction will range from a few seconds to several minutes depending on the composition of the feed. Typically, after a residence time of around 10 to 15 seconds, oxidation of the biomass is complete and the secondary water stream, and the products of the oxidation process entrained therein, are passed out of the reactor and into an expansion and separation stage 28, wherein the water and the reaction products are separated. The inorganic and inert fractions of the biomass feed will not be destructed in the oxidation process and will remain in the water stream exiting the reactor as inorganic solid salts ands inert solids. These solids S entrained within the secondary water stream may be removed by filtration, for example using a ceramic filter plate, cyclone separation, centrifugal separation or flow velocity reduction and deposition. Other by-products of the SCWO process will include supercritical carbon dioxide and supercritical nitrogen. Such may be recovered and may be passed through a suitable turbine to extract further energy therefrom or may be recovered for other uses.

Energy may be recovered from the feed stream of supercritical water, supercritical carbon dioxide and supercritical nitrogen downstream of the SCWO process by one or both of two processes, namely:—
using heat exchange processes to transfer heat energy to a heat sink, such as the hot water used in the power station either upstream or downstream of the boiler to generate electricity from steam turbines coupled to electricity generators and/or the biomass and water feeds into the reactor;
passing the feed stream of supercritical water, carbon dioxide and nitrogen into one or more turbines, such as steam turbines, gas turbines and/or hydro turbines, coupled to electricity generators.

In one embodiment, the secondary water stream passes through one or more second heat exchangers 30 before entering the expansion and separation stage 28, wherein the primary water stream upstream of the boiler 4 is heated by heat exchange with the high temperature secondary water stream. Alternatively the separated secondary water stream may be passed through the second heat exchanger 30 downstream of the expansion and separation stage 28. Alternatively the secondary water stream may be expanded, for example by doing work in a turbine, before heat exchange, thereby reducing the pressure of the water stream before cooling the water stream such that heat exchange takes place in a less corrosive environment.

The separated secondary water stream may then be returned to the first heat exchanger 22 before passing back into the compressor 24 and into the reactor 20 to repeat the process. Additionally, or alternatively, at least part of the separated secondary water stream may be used as a heat source for another stage of the thermodynamic cycle of the power station or for a separate use, such as community heating.

This arrangement enables the SCWO biomass oxidation process to be utilised for the efficient extraction of useful energy from a high water content biomass source without incurring substantial capital costs by utilising existing components and feed streams of an existing thermal power station to provide a hybrid power generation system with minimal impact upon the operation of the existing power station.

A hybrid thermal power station according to a second embodiment of the present invention is illustrated in FIG. 2. In this embodiment, the SCWO process is integrated more completely into the power station, whereby a primary water feed is used both to drive the steam turbine(s) of the power station and as a supercritical water feed stream for the SCWO biomass oxidation process.

The primary water feed is supplied into the primary boiler 100 by means of a feed pump 102. The primary water feed in the boiler is heated by a primary heat source, for example by the combustion of coal, gas or oil or by nuclear energy, to a temperature of around 540° C. at a pressure of around 148 bar. The primary feed stream is then compressed in a compressor 104 to a pressure of around 220 bar such that the temperature and pressure of the feed stream are beyond those of the critical point of water. The primary feed stream is then passed into a reactor 106, along with an oxidant, such as liquid oxygen, hydrogen peroxide or air, and an aqueous slurry of biomass B is injected into the reactor wherein it is oxidised, heating the primary feed stream. The oxidation of the biomass heats the primary feed stream to a temperature of over 600° C. The biomass slurry may be added to the primary feed stream at any point upstream of the reactor.

After a residence time of around 10 to 15 seconds, oxidation of the biomass is complete and the mixture of water and reaction products passes out of the reactor and into an expansion and separation stage 108, wherein the reaction products S are removed from the water, for example by filtration in a ceramic filter. The separated primary feed stream is then passed into one or more steam turbines 110 to drive a generator 112 to generate electricity before passing into a condenser stage 114 and back to the feed pump 102 to be returned to the boiler 100.

While the oxidising agent may be supplied from a separate source or storage means into the reactor, in a preferred embodiment, an electrolysis process, using electricity from the generator 8,112, is used to separate a portion of the feed stream downstream of or in the reactor into hydrogen and oxygen. The oxygen can then be used in the SCWO process while the hydrogen produced as a by-product during the product of oxygen can be extracted in the expansion and separation stage for use, either in a gas turbine for generating electricity, for use in a fuel cell, or for any other purpose. Alternatively other means for extracting oxygen, or one or more other oxidising agents, such as hydrogen peroxide, from the water feed stream passing into the reactor may be utilised, such as electrochemical or photochemical process, for example utilising UV radiation.

The three principal components of the reactor effluent stream will be water, carbon dioxide and nitrogen. These materials exist in different phases at different temperatures and pressures. They can therefore be recovered separately by careful selection of temperature and pressure and the use of a phase separation device such as a conventional or modified steam trap design, e.g. float or venturi aperture or other. The carbon dioxide may then be stored as a pressurised gas or liquid or in a suitable form for sequestration.

The carbon dioxide may also be used to as a nutrient for algal farming. Power Stations are commonly located near to a water body to provide cooling water for the condenser. The CO₂ could be used (along with the water heated in the condenser at in a controlled manner to produce algae in a lagoon. This algae may then be produced as a feedstock for the SCWO process.

The high pressure and temperature of the feed stream downstream of the reactor facilitates the separation and capture of carbon dioxide from the feed stream. The ability to capture carbon dioxide from the SCWO process is highly advantageous and can prevent the release of CO₂ to the atmosphere, improving the carbon balance of the power station.

Residual Water Treatment and Discharge/Recovery

The residual water, after energy recovery and the removal of solids, carbon dioxide and nitrogen may be treated by processes which may include but not be limited to;
ion exchange processes
membrane separations
filtration
precipitation
Other treatment processes

The treated water may then be discharged to the environment or recycled to be used as water for the dilution of biomass feed.

Inorganic Chemical Recovery

The solids removed in the solids recovery process and in the residual water treatment processes may have high concentrations of compounds such as phosphate/phosphorus which may be beneficial to separate and recover using techniques such as but not limited to;
dissolution
formation of derivatives
ion exchange processes
membrane separations
filtration
precipitation
Other separation processes

The present invention enables fossil fuels and/or nuclear energy or other primary combustible fuels, such as wood chips or other combustible biomass, to be supplemented by high water content biomass energy sources in the generation of electricity in a thermal power station and enables the efficient extraction of energy from high water content biomass sources, such as waste organic matter or plant matter, by the use of super critical water oxidation processes utilising existing high temperature and high pressure water streams from an existing power station to generate the required supercritical water and utilising the steam power generation processes of the power station to extract energy from the biomass oxidation process. The capital cost of the required boiler, steam turbine and compression plant is presently a barrier to the uptake of SCWO processes for energy production. By using the existing plant and working medium in a power station environment, the capital cost is greatly reduced and the SCWO process can operate at a scale that is both feasible and viable.

Oxygen consumption is typically the largest overhead associated with SCWO. By generating oxygen in situ, this overhead is removed and replaced with a relatively small consumption in electrical power.

A particularly suitable source of biomass for use in the present invention is grass, which can be readily grown on marginal quality land. Such material has not been hitherto used as a useful source of energy due to its high water content. Previous attempts to extract useful energy from grass crops have relied on the product of ethanol from grass by fermentation and distillation, a process which consumes almost as much energy as can be gained from the combustion of ethanol. The ability of SCWO to extract energy from high water content organic matter without requiring prior drying of the organic matter makes the method and apparatus of the present invention particularly suited to the generation of power from grass or silage, improving the carbon balance the electricity generation process.

The invention is not limited to the embodiments described herein but can be amended or modified without departing from the scope of the present invention.

1. A method of extracting energy from biomass, comprising the steps of raising the temperature and pressure of a feed stream of water to supercritical levels by means of a primary source of energy, and utilising said feed stream of water to oxidise biomass in a supercritical water oxidation (SCWO) process in a reactor to further increase the temperature and/or pressure of said feed stream of water.

2. A method as claimed in claim 1, wherein said biomass is added to the feed stream upstream of the reactor.

3. A method as claimed in claim 1, wherein said feed stream comprises an aqueous solution of biomass and water.

4. A method as claimed in claim 1, comprising the further step of generating electricity from said feed stream downstream of said SCWO process, either directly by passing the feed stream into one or more turbines, such as one or more of a steam turbine and/or a gas turbine and/or a hydro turbine, coupled to one or more electricity generators, or indirectly by transferring heat energy from said feed stream to a working fluid of one or more turbines coupled to one or more electricity generators.

5. A method as claimed in claim 1, wherein at least part of said feed stream downstream of said SCWO process is utilised as a source of energy, in particular as a source of heat and/or potential energy (pressure), either directly or indirectly.

6. A method as claimed in claim 1, wherein said primary source of energy comprises at least one of coal, oil, gas or a nuclear reactor.

7. A method as claimed in claim 1, wherein said step of raising the temperature and pressure of said feed stream of water to supercritical levels comprises heating a first flow of water to a first temperature at a first pressure by means of said primary source of energy and compressing said first flow of water to a second pressure, such that the temperature and pressure of the first flow of water are above those of the critical point of water whereby said first flow of water comprises said feed stream.

8. A method as claimed in claim 1, wherein said step of raising the temperature of said feed stream of water to supercritical levels comprises heating a first flow of water by means of said primary source of energy and heating a second flow of water by indirect heat exchange with said first flow of water whereby said second flow of water comprises said feed stream.

9. A method as claimed in claim 8, wherein said second flow of water is compressed to a supercritical pressure either upstream or downstream of said heat exchange process.

10. A method as claimed in claim 8, wherein said step of heating said first flow of water to said first temperature and first pressure comprises heating the first flow of water in a boiler by means of said primary source of energy.

11. A method as claimed in claim 1, wherein said SCWO process takes place in a reactor fed by said feed stream of water.

12. A method as claimed in claim 11, wherein said biomass is injected into said reactor and/or to the feed stream upstream of the reactor as an aqueous slurry.

13. A method as claimed in claim 12, wherein an oxidising agent is fed into said reactor and/or is mixed into the feed stream upstream of the reactor.

14. A method as claimed in claim 13, wherein said oxidising agent comprises one or more of oxygen, hydrogen peroxide, or air, preferably in liquefied form.

15. A method as claimed in claim 13, wherein said oxidising agent is generated from water, preferably from said feed stream of water, by UV radiation, electrolysis, other electrochemical processes or any other oxygen generating method.

16. A method as claimed in claim 15, wherein said oxidising agent generating method also generates hydrogen as a by-product.

17. A method as claimed in claim 16, wherein said hydrogen is recovered from the feed stream and/or from the water from which the oxygen is generated.

18. A method as claimed in claim 1, wherein said biomass is heated before entering the reactor.

19. A method as claimed in claim 18, wherein said biomass is heated to a temperature of at least 300° C. before entering the reactor.

20. A method as claimed in claim 18, wherein the biomass is heated by heat exchange with the feed stream downstream of the reactor.

21. A method as claimed in claim 1, wherein said method further comprises the steps of removing solids, such as ash, from said feed stream downstream of the reactor in a separation stage and preferably subsequently passing said separated feed stream of water into one or more turbines coupled to one or more electricity generators to generate electricity.

22. A method as claimed in claim 21, wherein said separation stage comprises one or more of cyclone separation, centrifugal separation, filtration or flow velocity reduction and deposition.

23. A method as claimed in claim 21, further comprising reducing the pressure of said feed stream downstream of the reactor.

24. A method as claimed in claim 23, wherein said pressure reduction takes place before or after said separation stage.

25. A method as claimed in claim 23, wherein said pressure reduction takes place before cooling the feed stream by heat exchange with a heat sink.

26. A method as claimed in claim 23, wherein said step of raising the temperature and pressure of said feed stream of water to supercritical levels comprises heating a first flow of water to a first temperature at a first pressure by means of said primary source of energy and compressing said first flow of water to a second pressure, such that the temperature and pressure of the first flow of water are above those of the critical point of water, wherein the pressure of said feed stream of water is reduced from said second pressure to said first pressure downstream of the reactor.

27. A method as claimed in claim 1, further comprising the steps of transferring heat from said feed stream of water downstream of said reactor to a further flow of water in a heat exchanger and preferably passing said further flow of water into one or more turbines coupled to one or more electricity generators to generate electricity.

28. A method as claimed in claim 27, wherein said further flow of water comprises at least part of a first flow of water heated by said primary heat source.

29. A method as claimed in claim 28, wherein said transfer of heat to said first flow of water takes place before it enters a boiler to be heated by said first heat source.

30. A method as claimed in claim 1, wherein by-products of said SCWO process are recovered from the feed stream downstream of the SCWO process.

31. A method as claimed in claim 30, wherein at least one of said by-products comprises one or more of supercritical CO₂, supercritical nitrogen and/or inorganic salts.

32. A method as claimed in claim 30, wherein energy is recovered from one or more of said by-products of the SCWO process.

33. A method as claimed in claim 32, wherein said energy is recovered by passing said one or more by-products through one or more turbines and/or passing said one or more by-products through one or more heat exchangers.

34. A method as claimed in claim 1 wherein the pressure of said feed stream downstream of said SCWO process is reduced before heat energy is extracted from the feed stream to reduce the corrosiveness of the feed stream.

35. A method as claimed in claim 34, wherein the pressure of the feed stream is reduced by passing the feed stream through one or more turbines.

36. A hybrid thermal power station for extracting useful energy from biomass fuels comprising means for heating a feed stream of water, by means of direct heating by a primary heat source, such as coal, gas, oil or nuclear power, or by heat exchange with a heat exchange medium heated by said primary heat source, a compressor for compressing said feed stream, whereby the temperature and pressure of said feed stream are increased to a temperature and pressure beyond its critical point, a reactor for receiving said supercritical feed stream for oxidising biomass in aqueous solution in a SCWO process to further heat the feed stream before utilising said feed stream, for example to drive one or more turbines.

37. A hybrid thermal power station as claimed in claim 36, wherein a separation means, such as a filter, is provided for removing solids from said feed stream downstream of said reactor, said feed stream being directly passed into said one or more turbines downstream of said separation means.

38. A hybrid thermal power station as claimed in claim 37, further comprising at least one heat exchanger arranged to transfer heat from said feed stream to a further stream of water, said further stream of water being subsequently passed into said one or more turbines downstream of said heat exchanger.

39. A hybrid thermal power station as claimed in claim 38, wherein said at least one heat exchanger is provided downstream of said reactor

40. A hybrid thermal power station as claimed in claim 38, wherein said at least one heat exchanger is provided within said reactor.

41. A method for extracting useful energy from biomass fuels as part of a hybrid electricity generating thermal power plant, utilising both a primary heat source, such as coal, gas, oil or nuclear power, and a secondary heat source in the form of biomass, whereby the biomass is oxidised in aqueous solution in a supercritical water oxidation (SCWO) process utilising energy from the primary heat source to heat and compress a feed stream of water to a temperature and pressure at or beyond its critical point.
